(19) United States
(12) Patent Application Publication
(10) Pub. No.: US 2014/0161976 A1
(43) Pub. Date: Jun. 12, 2014

(54) METHOD OF FORMING CORE-SHELL NANO PARTICLE FOR METAL INK

(71) Applicant: Electronics and Telecommunications Research Institute, Daejeon (KR)

(72) Inventors: Ji-Young OH, Daejeon (KR); Sang Chul LIM, Daejeon (KR); Seongdeok AHN, Daejeon (KR); Chan Woo PARK, Daejeon (KR); Jae Bon KOO, Daejeon (KR)

(21) Appl. No.: 13/905,666

(22) Filed: May 30, 2013

(30) Foreign Application Priority Data
Dec. 12, 2012 (KR) 10-2012-0144280

(51) Int. Cl. C09D 11/00

(52) U.S. Cl. CPC C09D 11/52
USPC 427/217

(57) ABSTRACT

Disclosed are methods of forming a core-shell nano particle for a metal ink. The method includes forming a metal oxide nano particle core, and forming a metal shell on a surface of the metal oxide nano particle core to form a core-shell nano particle.

### CROSS-REFERENCE TO RELATED APPLICATIONS

This U.S. non-provisional patent application claims priority under 35 U.S.C. §119 to Korean Patent Application No. 10-2012-0144280, filed on Dec. 12, 2012, the entirety of which is incorporated by reference herein.

### BACKGROUND

The inventive concept relates to methods of forming a core-shell nano particle for a metal ink and, more particularly, to methods of forming a core-shell nano particle including a metal oxide for a metal ink.

A large area electrode and a flexible substrate have been demanded in a display device, a thin film solar cell, and a radio-frequency identification (RFID). Additionally, materials based on a low cost solution process are being developed for reducing production costs and/or process costs. In particular, low cost materials for a transparent electrode are developed with the development of a transparent display.

An inkjet printing technique is a new manufacture process developed for improving productivity and reducing manufacture costs in a display industry. Printer head techniques have been sufficiently developed in the inkjet printing technique. However, an ink design still remains as a difficult problem. A metal ink including uniform and stable nano particles should be manufactured for obtaining excellent printed patterns. The metal ink is mainly used as a material for forming a fine conductive line or a conductive layer. Thus, the metal ink may include metal nano particles having sizes of several or several tens nanometers. Recently, an inkjet technique using a metal ink of silver nano particles has been developed. However, manufacture costs may increase by expensive silver nano particles.

### SUMMARY

Embodiments of the inventive concept may provide methods of forming a low cost core-shell nano particle for a metal ink.

In an aspect, embodiments of the inventive concept provide a method of forming a core-shell nano particle for a metal ink. The method may include: forming a metal oxide nano particle core; and forming a metal shell on a surface of the metal oxide nano particle core to form a core-shell nano particle.

In an embodiment, the metal oxide nano particle core may be a transparent metal oxide nano particle.

In an embodiment, the metal oxide nano particle core may have a size of about 1 nm to about 100 nm.

In an embodiment, forming the metal oxide nano particle core may include: preparing a metal oxide precursor; preparing a reagent for synthesizing a metal oxide; and mixing the metal oxide precursor with the reagent to react the metal oxide precursor with the reagent.

In an embodiment, the metal oxide precursor may be a zinc oxide (ZnO) precursor, a tin oxide (SnO₂) precursor, an indium-zinc-gallium oxide (IZGO) precursor, or an indium-zinc oxide (IZO) precursor.

In an embodiment, forming the metal shell on the surface of the metal oxide nano particle core may include: preparing a metal oxide nano particle core solution including the metal oxide nano particle core and a dispersing solution; adding a metal shell precursor into the metal oxide nano particle core solution; adding an oxidizer into the metal oxide nano particle core solution including the metal shell precursor; and stirring the metal oxide nano particle core solution including the metal shell precursor and the oxidizer.

In an embodiment, the metal shell precursor may be a gold precursor or a silver precursor.

In an embodiment, after forming the core-shell nano particle, the method may further include: mixing the core-shell nano particle with an ink composition to form a metal ink.

### BRIEF DESCRIPTION OF THE DRAWINGS

The inventive concept will become more apparent in view of the attached drawings and accompanying detailed description.

FIG. 1 is a cross-sectional view illustrating a core-shell nano particle according to example embodiments of the inventive concept;

FIG. 2 is a flowchart illustrating a method of forming a ink including a core-shell nano particle according to example embodiments of the inventive concept;

FIGS. 3A and 3B are photographs of a transmission electron microscope (TEM) illustrating a zinc oxide nano particle formed by experiment examples according to example embodiments of the inventive concept;

FIG. 3C is a graph of an X-ray diffractometer (XRD) illustrating a zinc oxide nano particle formed by an experiment according to example embodiments of the inventive concept;

FIG. 4A is a photograph of a transmission electron microscope (TEM) illustrating a core-shell nano particle formed by an experiment example 1 according to example embodiments of the inventive concept;

FIG. 4B is a graph of an energy dispersive x-ray spectroscopy (EDX) illustrating a core-shell nano particle formed by an experiment example 1 according to example embodiments of the inventive concept;

FIG. 5A is a photograph of a transmission electron microscope (TEM) illustrating a core-shell nano particle formed by an experiment example 2 according to example embodiments of the inventive concept; and

FIG. 5B is a graph of an energy dispersive x-ray spectroscopy (EDX) illustrating a core-shell nano particle formed by an experiment example 2 according to example embodiments of the inventive concept.

### DETAILED DESCRIPTION OF THE EMBODIMENTS

The inventive concept will now be described more fully hereinafter with reference to the accompanying drawings, in which exemplary embodiments of the inventive concept are shown. The advantages and features of the inventive concept and methods of achieving them will be apparent from the following exemplary embodiments that will be described in more detail with reference to the accompanying drawings. It should be noted, however, that the inventive concept is not limited to the following exemplary embodiments, and may be implemented in various forms. Accordingly, the exemplary embodiments are provided only to disclose the inventive concept and let those skilled in the art know the category of the inventive concept. In the drawings, embodiments of the inventive concept are not limited to the specific examples provided herein and are exaggerated for clarity.

The terminology used herein is for the purpose of describing particular embodiments only and is not intended to limit the invention. As used herein, the singular terms “a,” “an” and “the” are intended to include the plural forms as well, unless the context clearly indicates otherwise. As used herein, the term “and/or” includes any and all combinations of one or more of the associated listed items. It will be understood that when an element is referred to as being “connected” or “coupled” to another element, it may be directly connected or coupled to the other element or intervening elements may be present.

Similarly, it will be understood that when an element such as a layer, region or substrate is referred to as being “on” another element, it can be directly on the other element or intervening elements may be present. In contrast, the term “directly” means that there are no intervening elements. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

Additionally, the embodiment in the detailed description will be described with sectional views as ideal exemplary views of the inventive concept.

Accordingly, shapes of the exemplary views may be modified according to manufacturing techniques and/or allowable errors. Therefore, the embodiments of the inventive concept are not limited to the specific shape illustrated in the exemplary views, but may include other shapes that may be created according to manufacturing processes. Areas exemplified in the drawings have general properties, and are used to illustrate specific shapes of elements. Thus, this should not be construed as limited to the scope of the inventive concept.

It will be also understood that although the terms first, second, third etc. may be used herein to describe various elements, these elements should not be limited by these terms. These terms are only used to distinguish one element from another element. Thus, a first element in some embodiments could be termed a second element in other embodiments without departing from the teachings of the present invention. Exemplary embodiments of aspects of the present inventive concept explained and illustrated herein include their complementary counterparts. The same reference numerals or the same reference designators denote the same elements throughout the specification.

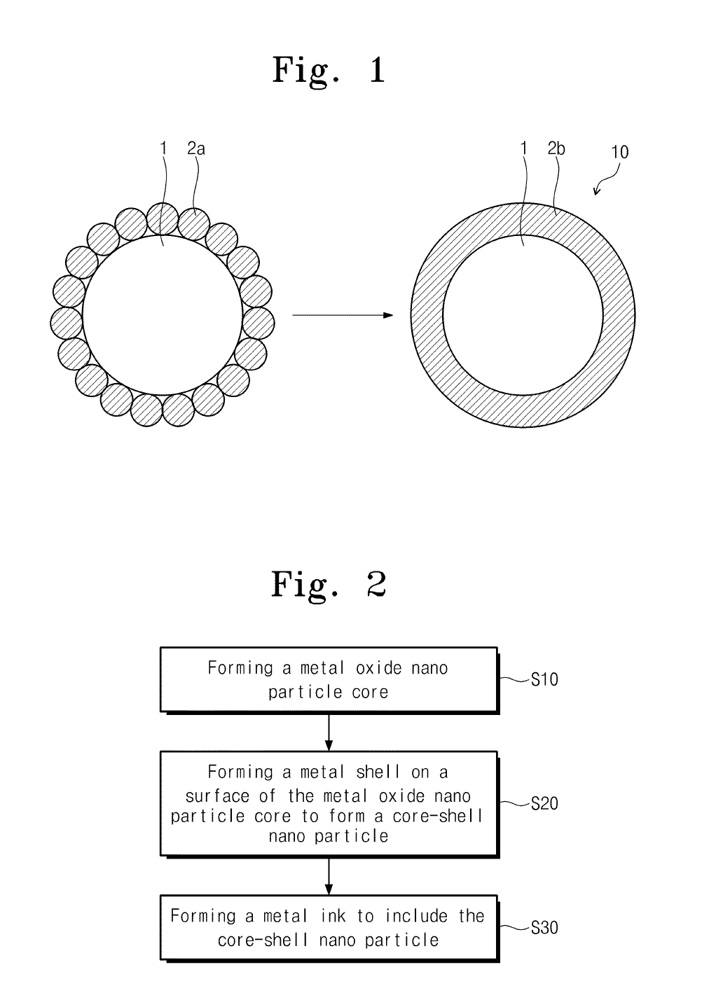

FIG. 1 is a cross-sectional view illustrating a core-shell nano particle according to example embodiments of the inventive concept.

Referring to FIG. 1, a core-shell nano particle 10 may include a core 1 and a shell 2b covering the core 1. The core 1 may include a metal oxide, and the shell 2b may include a metal. Metal particles 2a formed on a surface of the core 1 may be agglomerated to form the metal shell 2b.

The core 1 may be a transparent metal oxide nano particle. The core 1 may include, for example, zinc oxide (ZnO), tin oxide (SnO₂), indium-zinc-gallium oxide (IZGO), or indium-zinc oxide (IZO). The core 1 may have a size of about 1 nm to about 100 nm. If the size of the core 1 is greater than about 100 nm, dispersibility of the cores 1 may be deteriorated in a metal ink. The core 1 may have one of various shapes. In an embodiment, the core 1 may have a globular shape, as illustrated in FIG. 1. However, the inventive concept is not limited thereto. In other embodiments, the core 1 may have a needle shape, a granular shape, a micro-spherical shape, a bar shape, or an amorphous shape.

The metal shell 2b may include a conductive metal material. For example, the metal shell 2b may include gold (Au) or silver (Ag). Since the material of the metal shell 2b is an opaque metal, the metal shell 2b should be thin in order that the metal shell 2b is transparent.

The core-shell nano particle 10 includes the core 1 including the transparent metal oxide and the metal shell 2b, such that the core-shell nano particle 10 is transparent and has conductibility. The core-shell nano particle 10 is used as a metal nano particle included in the metal ink. Thus, a manufacture cost of the metal ink including the core-shell nano particles 10 may be lower than that of a conventional metal ink including expensive silver nano particles. As a result, a transparent conductive layer may be inexpensively formed using the metal ink including the core-shell nano particles 10.

FIG. 2 is a flowchart illustrating a method of forming a ink including a core-shell nano particle according to example embodiments of the inventive concept.

Referring to FIG. 2, a metal oxide nano particle core is formed (S10).

A metal oxide core precursor may be dissolved in a solvent. The solvent including the metal oxide core precursor may be added into a reagent for synthesizing a metal oxide. The solvent including the metal oxide core precursor may react with the reagent in an ultrasonic reacting container for about 24 hours, thereby forming a metal oxide core reactant. The metal oxide core precursor may be a zinc oxide (ZnO) precursor, a tin oxide (SnO₂) precursor, an indium-zinc-gallium oxide (IZGO) precursor, or an indium-zinc oxide (IZO) precursor. The solvent may be methanol. The metal oxide core reactant may be separated using a centrifugal separator, so that a reaction by-product may be removed and metal oxide nano particle cores may be formed. The metal oxide nano particle core may have a needle shape, a granular shape, a globular shape, a micro-spherical shape, a bar shape, or an amorphous shape. The metal oxide nano particle core is transparent.

A metal shell is formed on a surface of the metal oxide nano particle core, thereby forming a core-shell nano particle (S20).

The metal oxide nano particle cores may be dispersed in a dispersing solvent to form a metal oxide nano particle core solution. The dispersing solvent may control a concentration of the core-shell nano particles when the core-shell nano particles are formed. The dispersing solvent may be ethanol.

A metal shell precursor may be added into the metal oxide nano particle core solution and then they may be mixed. An oxidizer may be added into the metal oxide nano particle core solution mixed with the metal shell precursor, and then the metal oxide nano particle core solution including the metal shell precursor and the oxidizer may be stirred for about 2 hours to form the core-shell nano particles. The metal shell precursor may be a silver precursor or a gold precursor. The oxidizer may be triethanolamine The core-shell nano particles may be cleaned with ethanol by a centrifugal separator.

A metal ink is formed to include the core-shell nano particles (S30).

The core-shell nano particles may be added into an ink composition to form the metal ink. The ink composition may include a first solvent, a second solvent, and a dispersant. The first solvent may have a boiling point of about 150 degrees Celsius or more, and the second solvent may have a boiling point lower than about 150 degrees Celsius. The first solvent may include at least one of alcohol-based solvents and polyhydric alcohol derivative-based solvents. For example, the first solvent may include at least one of terpineol, ethyleneglycolmonoethyletheracetate, ethyleneglycolmonobutylether, ethyleneglycolmonobutyletheracetate, propyleneglycolmonoethyletheracetate, propyleneglycolmonobutylether, propyleneglycolmonobutyletheracetate, diethyleneglycoldimethylether, diethyleneglycoldiethylether, diethyleneglycolethylmethylether, diethyleneglycolmonomethylether, diethyleneglycolmonomethyletheracetate, diethyleneglycolmonoethylether, diethyleneglycolmonoethyletheracetate, diethyleneglycolmonobutylether, and diethyleneglycolmonobutyletheracetate. For example, the second solvent may include at least one of acetone, ethylacetate, ethylalcohol, methylethylketone, isopropylalcohol, isopropylacetate, methylisobutylketone, and butylalcohol. The dispersant may be an ester-based dispersant. For example, the dispersant may be polyester. A concentration of the dispersant may be within a range of about 0.05 wt % to about 10 wt %.

A conductive metal layer may be formed using the metal ink including the core-shell nano particles according to embodiments of the inventive concept by a gravure printing method, an inkjet method, a printing method, a screen printing method, an imprint method, or a spin coating method. The printing methods may easily form a low cost and/or a large area pattern or layer unlike a convention method of forming a pattern or layer. Additionally, the printing methods may enable one-step formation process of a conductive pattern.

### EXPERIMENT EXAMPLE 1

Formation of a Zinc Oxide Core Nano Particle

Zinc acetate of 8.836 g is dissolved in methanol of 75 ml. A 1M KOH-methanol solution of 39 ml is added into the methanol in which the zinc acetate is dissolved. The zinc acetate, the methanol, and the KOH-methanol solution react with each other in an ultrasonic reacting container for about 24 hours. The zinc acetate and the KOH-methanol solution react with each other to form a reactant. A reaction by-product and zinc oxide nano particles included in the reactant may be separated from each other by a centrifugal separator. The reaction by-product is removed to obtain the zinc oxide nano particles.

Formation of Zinc Oxide Core-Silver Shell Nano Particle

Ethanol of 30 ml is additionally provided to ethanol (10 ml) in which zinc oxide nano particles (3.4 wt %) are dispersed. Thus, a zinc oxide nano particle solution is formed. The zinc oxide nano particle solution of 25 ml into which silver nitrate (AgNO₃) is added may drop in 0.0045M triethanolamine (TEA) of 25 ml, and then they are stirred for 2 hours to form a brown reactant. The brown reactant is cleaned with ethanol by a centrifugal separator, thereby obtaining zinc oxide core-silver shell nano particles.

### EXPERIMENT EXAMPLE 2

Formation of Zinc Oxide Core-Gold Shell Nano Particle

Ethanol of 30 ml is additionally provided to ethanol (10 ml) in which zinc oxide nano particles (3.4 wt %) are dispersed. Thus, a zinc oxide nano particle solution is formed. The zinc oxide nano particle solution of 25 ml into which chloroauric acid (HAuCl₄) is added may drop in 0.0045M triethanolamine (TEA) of 25 ml, and then they are stirred for 2 hours to form a brown reactant. The brown reactant is cleaned with ethanol by a centrifugal separator, thereby obtaining zinc oxide core-gold shell nano particles.

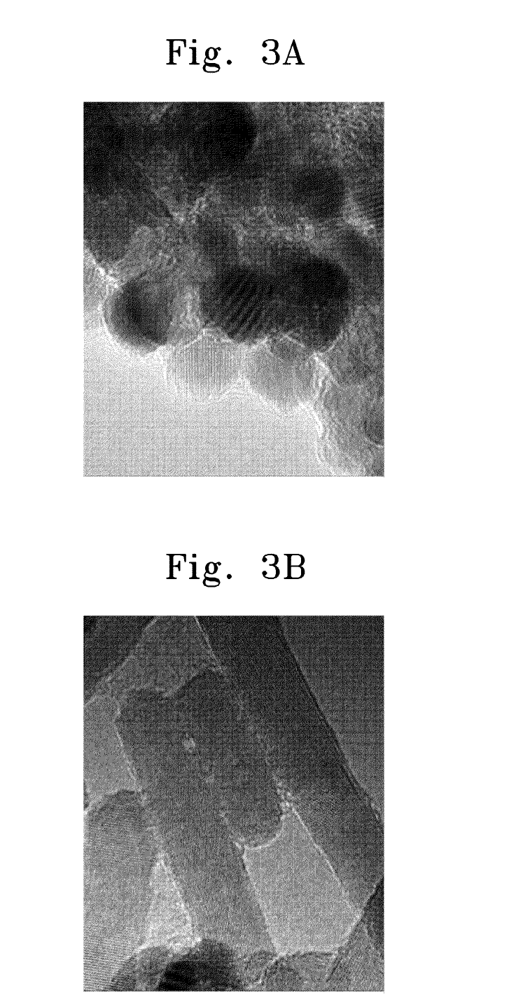

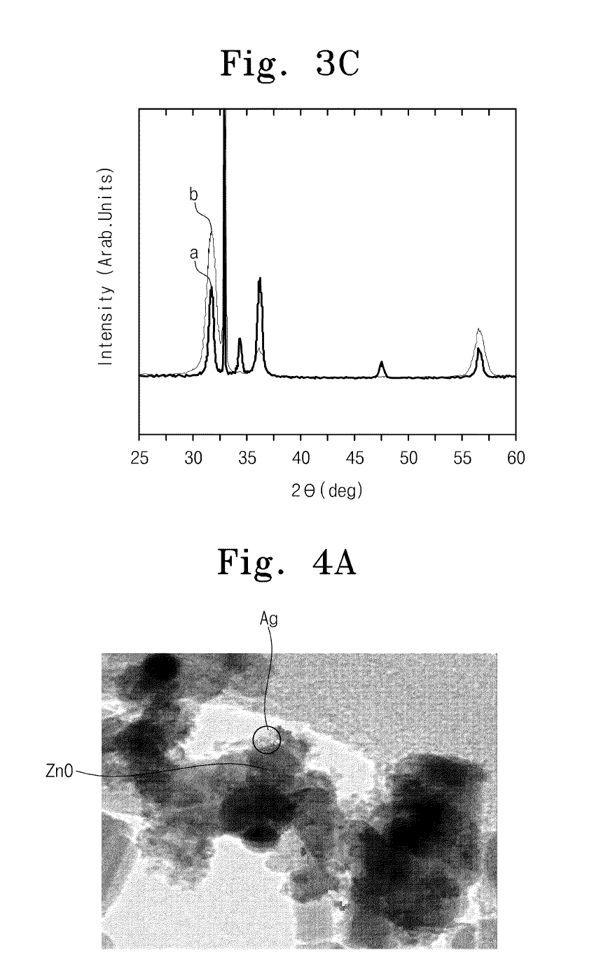

FIGS. 3A and 3B are photographs of a transmission electron microscope (TEM) illustrating a zinc oxide nano particle formed by experiment examples according to example embodiments of the inventive concept. FIG. 3C is a graph of an X-ray diffractometer (XRD) illustrating a zinc oxide nano particle formed by an experiment according to example embodiments of the inventive concept.

The zinc oxide nano particles having globular shapes or nano bar shapes are confirmed through the photographs of the TEM illustrated in FIGS. 3A and 3B. Additionally, the zinc oxide nano particles a having the globular shapes and the zinc oxide nano particles b having the bar shapes are verified through the graphs of the XRD illustrated in FIG. 3C.

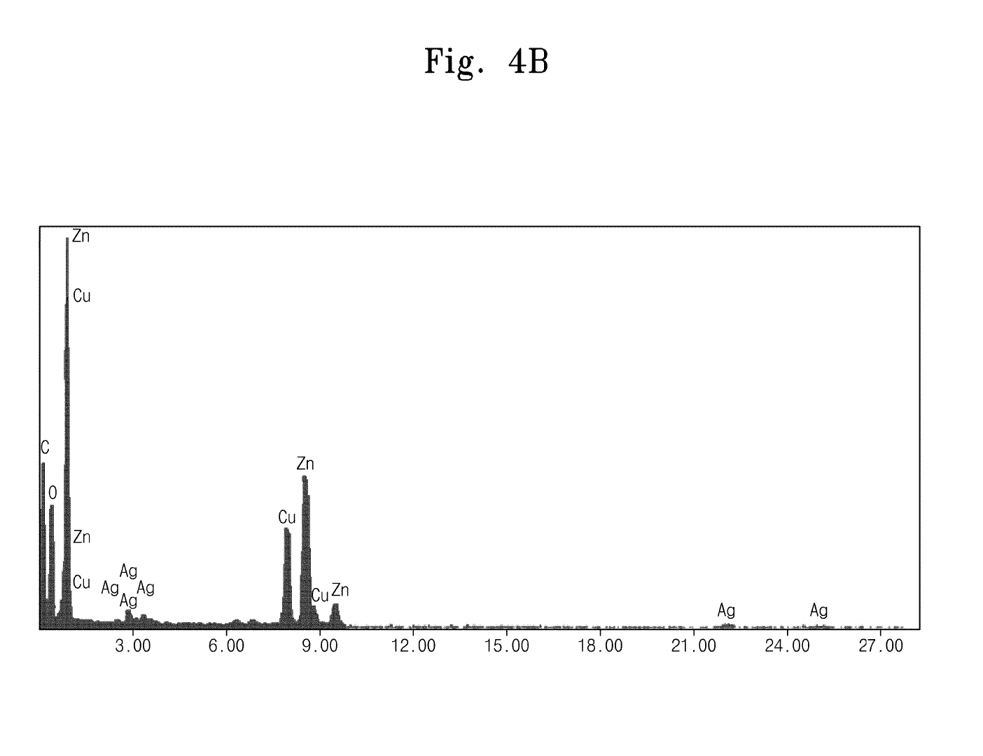

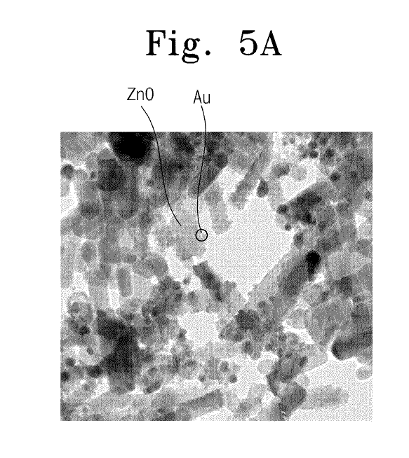

FIG. 4A is a photograph of a transmission electron microscope (TEM) illustrating a core-shell nano particle formed by an experiment example 1 according to example embodiments of the inventive concept. FIG. 4B is a graph of an energy dispersive x-ray spectroscopy (EDX) illustrating a core-shell nano particle formed by an experiment example 1 according to example embodiments of the inventive concept.

Referring to FIG. 4A, it is confirmed that the zinc oxide core-silver shell nano particles include zinc oxide particles and silver shells adhered to surfaces of the zinc oxide particles. Silver is detected from the zinc oxide core-silver shell nano particles by the EDX, as illustrated in FIG. 4B.

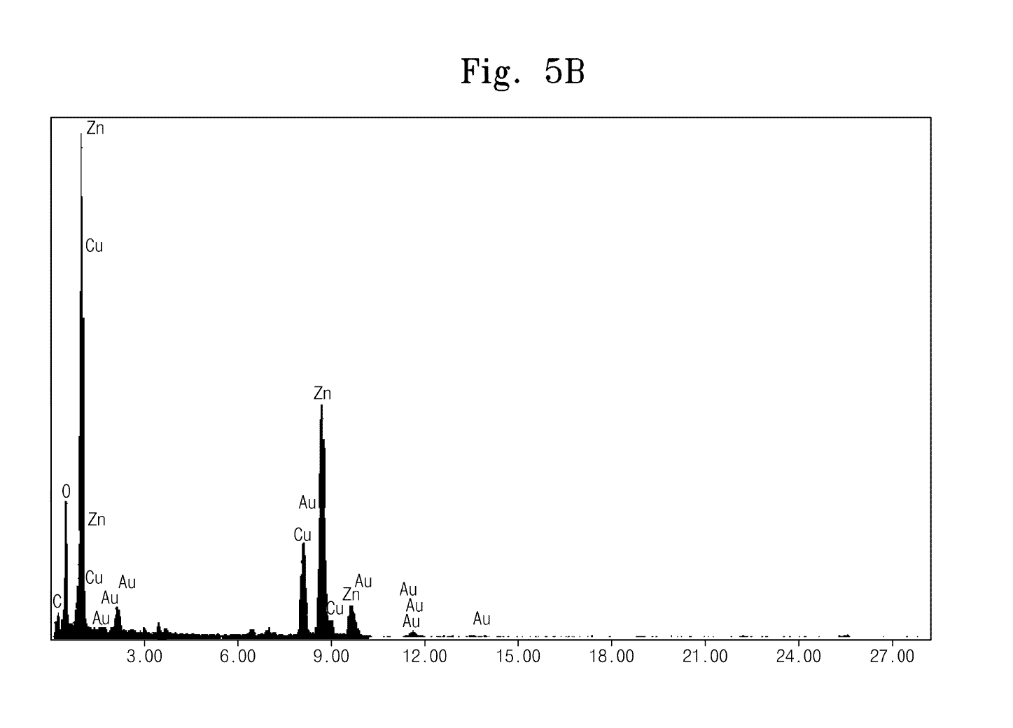

FIG. 5A is a photograph of a transmission electron microscope (TEM) illustrating a core-shell nano particle formed by an experiment example 2 according to example embodiments of the inventive concept. FIG. 5B is a graph of an energy dispersive x-ray spectroscopy (EDX) illustrating a core-shell nano particle formed by an experiment example 2 according to example embodiments of the inventive concept.

Referring to FIG. 5A, it is confirmed that the zinc oxide core-gold shell nano particles include zinc oxide particles and gold shells adhered to surfaces of the zinc oxide particles. Gold is detected from the zinc oxide core-gold shell nano particles by the EDX, as illustrated in FIG. 5B.

According to embodiments of the inventive concept, the core-shell nano particle includes the core having the transparent metal oxide and the shell having the conductive metal. Thus, the core-shell nano particle is transparent and has the conductibility. The core-shell nano particle is used as the metal nano particle in the metal ink. Thus, the transparent conductive layer may be inexpensively formed.

While the inventive concept has been described with reference to example embodiments, it will be apparent to those skilled in the art that various changes and modifications may be made without departing from the spirit and scope of the inventive concept. Therefore, it should be understood that the above embodiments are not limiting, but illustrative. Thus, the scope of the inventive concept is to be determined by the broadest permissible interpretation of the following claims and their equivalents, and shall not be restricted or limited by the foregoing description.

What is claimed is:

1. A method of forming a core-shell nano particle for a metal ink, the method comprising:
forming a metal oxide nano particle core; and
forming a metal shell on a surface of the metal oxide nano particle core to form a core-shell nano particle.

2. The method of claim 1, wherein the metal oxide nano particle core is a transparent metal oxide nano particle.

3. The method of claim 1, wherein the metal oxide nano particle core has a size of about 1 nm to about 100 nm.

4. The method of claim 1, wherein forming the metal oxide nano particle core comprises:
preparing a metal oxide precursor;
preparing a reagent for synthesizing a metal oxide; and
mixing the metal oxide precursor with the reagent to react the metal oxide precursor with the reagent.

5. The method of claim 4, wherein the metal oxide precursor is a zinc oxide (ZnO) precursor, a tin oxide (SnO₂) precursor, an indium-zinc-gallium oxide (IZGO) precursor, or an indium-zinc oxide (IZO) precursor.

6. The method of claim 1, wherein forming the metal shell on the surface of the metal oxide nano particle core comprises:
preparing a metal oxide nano particle core solution including the metal oxide nano particle core and a dispersing solution;
adding a metal shell precursor into the metal oxide nano particle core solution;
adding an oxidizer into the metal oxide nano particle core solution including the metal shell precursor; and
stirring the metal oxide nano particle core solution including the metal shell precursor and the oxidizer.

7. The method of claim 6, wherein the metal shell precursor is a gold precursor or a silver precursor.

8. The method of claim 1, after forming the core-shell nano particle, further comprising:
mixing the core-shell nano particle with an ink composition to form a metal ink.
